(19) United States
(12) Patent Application Publication
(10) Pub. No.: US 2007/0202263 A1
(43) Pub. Date: Aug. 30, 2007

(54) Process For Producing Coated Sheet

(76) Inventors: Ryu Kitamura, Yokohama-shi (JP); Kazuyoshi Wakata, Kawasaki-shi (JP); Yasuto Tai, Yokohama-shi (JP); Motoko Hiraki, Warabi-shi (JP); Shinichi Asano, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/590,308

(22) PCT Filed: Feb. 24, 2005
(86) PCT No.: PCT/JP05/03027

§ 371 Date: Mar. 20, 2007

(30) Foreign Application Priority Data
Feb. 25, 2004 (JP) 2004-048905

(51) Int. Cl. B05D 7/00

(52) U.S. Cl. 427/407.1

(57) ABSTRACT

A process for producing a coated sheet, in which there can be formed a coating layer simultaneously attaining an ink absorption rate and coating film cracking control suitable for use as an inkjet recording layer, in particular, there can be realized high gloss, high ink absorption, high printing density and high image quality required for use as a glossy inkjet recording sheet. There is provided a process for producing a coated sheet, comprising coating a support, or undercoat layer superimposed on the support, with a coating liquid containing a thermosensitive polymeric compound reversibly exhibiting hydrophilicity and hydrophobicity depending on temperature change, characterized in that the coating liquid containing a thermosensitive polymeric compound is applied concurrently with application of a treatment liquid whose temperature is in the range in which the thermosensitive polymeric compound exhibits hydrophilicity, or after the application of the treatment liquid without drying after the application.

### TECHNICAL FIELD

The present invention relates to a process for producing a coated sheet, and particularly relates to a process for producing a coated sheet available for inkjet recording. In accordance with the process for producing a coated sheet of the present invention, it is possible to form a coating layer simultaneously attaining an ink absorption rate and coating film crack control suitable for use as an inkjet recording layer, in particular, there can be realized high gloss, high ink absorption, high printing density and high image quality (dot roundness) required for use as a glossy inkjet recording sheet.

Priority is claimed on Japanese Patent Application No. 2004-048905, filed Feb. 25, 2004, the content of which is incorporated herein by reference.

### BACKGROUND ART

An inkjet recording system in which aqueous ink is ejected from a fine nozzle onto an inkjet recording sheet to form an image on the surface of the inkjet recording sheet has been widely used in terminal printers, facsimiles, plotters, sheet feeding printers, or the like, due to their low noise during recording, ease of forming full-color images, possibility of performing high-speed recording, lower cost than other printing devices, and so forth.

In recent years, enhancement of the ink absorption rate has been required due to rapid spread, enhanced detail, and increased speed of printers, and realization of image uniformity comparable to that of silver halide photography has been strongly demanded since the advent of digital cameras. Also, further enhancement of image recording density and glossiness has been demanded so as to provide recorded image qualities close to those of photographic images.

On the other hand, improvement of ink per se has been proposed so as to realize image preservability comparable to that of silver halide photography, and ink with excellent water resistance and light resistance in which a hydrophobic coloring pigment is dispersed (hereinafter, referred to as pigment ink) has become widely used in addition to conventional mainstream aqueous dye ink containing a coloring agent having a high hydrophilicity (hereinafter, referred to as dye ink).

Since the coloring pigment contained in the pigment ink tends to be retained on the coating surface so that the pigment ink lacks fixability and scuff resistance on highly glossy inkjet recording sheets conventionally used for application of dye ink, recording media that enable both dye and pigment inks to be used for printing high quality images are strongly demanded.

According to methods disclosed in Japanese Patent Application, First Publication No. H 7-276789 (see Patent Document 1), Japanese Patent Application, First Publication No. H 9-183267 (see Patent Document 2), Japanese Patent Application, First Publication No. H9-286165 (see Patent Document 3), and Japanese Patent Publication No. 3325141 (see Patent Document 4), ink absorption rate and cracking are conventionally controlled by using an extremely fine pigment and polyvinyl alcohol (hereinafter, referred to as PVA) as basic components of a recording layer so as to realize image quality comparable to that of silver halide photography. However, the control of cracking in such a way causes problems such as a significant reduction in productivity due to the suppression of drying and a significant reduction in coating stability due to use of PVA having a high degree of polymerization. In a method disclosed in Japanese Patent Application, First Publication No. 2000-218927 (see Patent Document 5), although gelatin is used for the purpose of controlling cracking of the coating film due to its thickening effects shown at low temperature, gelatin exhibits an inferior binding force to that of PVA and tends to render a coating film opaque, and so there are problems such as difficulties in completely preventing the occurrence of cracking and realizing photographic tone image qualities.

According to methods disclosed in Japanese Patent Publication No. 3321700 (see Patent Document 6), Japanese Patent Application, First Publication No. 2003-231342 (see Patent Document 7), and the like, a coating material is thickened or gelatinized by containing a boron-containing compound in a coating material or applying the boron-containing compound concurrently with the application of the coating material so that the occurrence of cracking on a coating film is easily controlled. Although such methods are highly effective for controlling the occurrence of cracking on a coating film, the coating film tends to become easily folded and then cracked due to cross-linking between the boron compound and PVA, and the coating film becomes particularly weak under low humidity conditions, which is a serious problem. Moreover, since the boron compound is a substance regulated by emission standards, alternative methods have been strongly demanded in terms of environmental protection.

Japanese Patent Application, First Publication No. 2002-160439 (see Patent Document 8) discloses a study for easily controlling the occurrence of cracking without using any boron compounds. However, it is difficult to recognize such a method as an easy-to-use method, because in the method a coating material is made to be a hydrogel by electron irradiation, and so expensive electron irradiation equipment is required, and a base material is significantly damaged by electron irradiation.

In recent years, a method in which the occurrence of cracking is controlled to realize image qualities comparable to those of silver halide photography by using a polymeric compound as a binder, the polymeric compound exhibiting hydrophilicity at a constant temperature (a thermosensitive point thereof) or below, but exhibiting hydrophobicity at a temperature above the thermosensitive point has been proposed as disclosed in Japanese Patent Application, First Publication No. 2003-40916 (see Patent Document 9). However, since the coating material is cooled and then dried after coating, a cooling zone is required to be disposed before a drier, and so the burden of equipment is heavy. Moreover, the cooling efficiency is low even when cooling is cared out at the cooling zone, and thereby rapidly thickening the coating material and easily solidifying the surface of the coating material are difficult, and so the method is not suitable for controlling the occurrence of cracking.

Patent Document 1: Japanese Patent Application, First Publication No. H 7-276789.

Patent Document 2: Japanese Patent Application, First Publication No. H 9-183267.

Patent Document 3: Japanese Patent Application, First Publication No. H9-286165.

Patent Document 4: Japanese Patent Publication No. 3325141.

Patent Document 5: Japanese Patent Application, First Publication No. 2000-218927.

Patent Document 6: Japanese Patent Publication No. 3321700.

Patent Document 7: Japanese Patent Application, First Publication No. 2003-231342.

Patent Document 8: Japanese Patent Application, First Publication No. 2002-160439.

Patent Document 9: Japanese Patent Application, First Publication No. 2003-40916.

### DISCLOSURE OF THE INVENTION

### Problems to be Solved by the Invention

The present invention provides a process for producing a coated sheet by which the above-mentioned problems are solved and ink absorption rate and coating film cracking control can be easily achieved. In particular, the present invention provides a process for producing a coated sheet for producing an inkjet recording sheet having excellent high gloss, high ink absorption, high printing density, and high image quality (dot roundness) required for use as a glossy inkjet recording sheet.

### MEANS FOR SOLVING THE PROBLEMS

As a result of accumulated investigation carried out so as to solve the above-mentioned problems, the inventors of the present invention have found that the above-mentioned problems can be solved by using a particular production process, and completed the present invention.

<1> A process for producing a coated sheet in which a support or an undercoat layer superimposed on the support is coated with a coating liquid containing a thermosensitive polymeric compound reversibly exhibiting hydrophilicity and hydrophobicity depending on temperature change, characterized by including: a step of applying on the support or the undercoat layer superimposed on the support a treatment liquid whose temperature is in a range in which the thermosensitive polymeric compound exhibits hydrophilicity; and a step of applying the coating liquid containing the thermosensitive polymeric compound concurrently with the application of the treatment liquid or after the application of the treatment liquid without drying after the application.

<2> A process for producing a coated sheet according to <1>, in which the coating liquid containing the thermosensitive polymeric compound is thickened or gelatinized at a temperature within a range in which the thermosensitive polymeric compound exhibits hydrophilicity.

<3> A process for producing a coated sheet according to <1> or <2>, in which a solvent of the treatment liquid is water.

<4> A process for producing a coated sheet according to any one of <1> to <3>, in which the treatment liquid contains at least one selected from the group consisting of cationic polymers and water-soluble polyvalent metal salts.

<5> A process for producing a coated sheet according to any one of <1> to <4>, in which the coating liquid containing the thermosensitive polymeric compound contains a pigment.

<6> A process for producing a coated sheet according to any one of <1> to <5>, in which the coating liquid containing the thermosensitive polymeric compound contains a cationic compound.

<7> A process for producing a coated sheet according to any one of <1> to <6>, in which the thermosensitive polymeric compound exhibits hydrophobicity at a temperature no lower than a thermosensitive point thereof, but exhibits hydrophilicity at a temperature no higher than the thermosensitive point.

<8> A process for producing a coated sheet according to <7>, in which the temperature of the coating liquid is lower than the thermosensitive point of the thermosensitive polymeric compound by 10° C. or more.

<9> A process for producing a coated sheet according to any one of <1> to <8>, in which the coating liquid containing the thermosensitive polymeric compound contains inorganic fine particles.

<10> A process for producing a coated sheet according to any one of <1> to <9>, in which, after a porous layer containing inorganic fine particles and a binder as main components thereof is formed on the support, the treatment liquid is applied and the coating liquid containing the thermosensitive polymeric compound is applied.

<11> A process for producing a coated sheet according to any one of <1> to <10>, including a step in which, after the coating liquid containing the thermosensitive polymeric compound is applied, the resultant material is brought into contact with and pressed against a mirror-finished drum and dried.

<12> A process for producing a coated sheet according to any one of <1> to <11>, including a step in which a coating fluid containing colloidal fine particles as a main component thereof is further applied onto the coating layer in which the coating liquid containing the thermosensitive polymeric compound is dried.

<13> A process for producing a coated sheet according to any one of <1> to <12>, in which the coated sheet is a recording sheet.

<14> A process for producing a coated sheet according to any one of <1> to <13>, in which the coated sheet is an inkjet recording sheet.

<15> A process for producing an inkjet recording coated sheet, in which a porous layer containing inorganic fine particles and a binder as main components thereof is formed on a support, and then a coating liquid containing a thermosensitive polymeric compound reversibly exhibiting hydrophilicity and hydrophobicity depending on temperature change and inorganic fine particles is applied, characterized by including: a step of applying on the porous layer a treatment liquid whose temperature is in the range in which the thermosensitive polymeric compound exhibits hydrophilicity; and a step of applying the coating liquid containing the thermosensitive polymeric compound and the inorganic fine particles concurrently with the application of the treatment liquid or after the application of the treatment liquid without drying after the application.

<16> A process for producing a coated sheet according to <15>, in which the porous layer has peaks in a pore distribution curve within each range of 0.1 to 10 μm and 0.5 μm or less, and a pore volume of 0.5 ml/g or more.

The present invention further includes the following aspects.

(1) A process for producing an inkjet recording sheet in which an ink receiving layer containing a thermosensitive polymeric compound that does not thicken a coating liquid thereof at a temperature no lower than a thermosensitive point thereof but thickens or gelatinizes the coating liquid thereof at a temperature below the thermosensitive point and inorganic fine particles is formed on a support, characterized in that the coating liquid containing the thermosensitive polymeric compound and the inorganic fine particles is applied concurrently with application of a treatment liquid whose temperature is in the range in which the thermosensitive polymeric compound is thickened or gelatinized, or after the application of the treatment liquid without drying after the application.

(2) A process for producing an inkjet recording sheet according to (1), in which the coating liquid containing the thermosensitive polymeric compound is thickened or gelatinized at a temperature within a range in which the thermosensitive polymeric compound exhibits hydrophilicity.

(3) A process for producing an inkjet recording sheet according to (1) or (2), in which a solvent of the treatment liquid is water.

(4) A process for producing an inkjet recording sheet according to any one of (1) to (3), in which the treatment liquid contains at least one selected from the group consisting of cationic polymers and water-soluble polyvalent metal salts.

(5) A process for producing an inkjet recording sheet according to any one of (1) to (4), in which the coating liquid containing the thermosensitive polymeric compound contains a cationic compound.

(6) A process for producing an inkjet recording sheet according to any one of (1) to (5), in which the thermosensitive polymeric compound exhibits hydrophobicity at a temperature no lower than the thermosensitive point and exhibits hydrophilicity at a temperature no higher than the thermosensitive point.

(7) A process for producing an inkjet recording sheet according to (6), in which the thermosensitive point is within a range from 15 to 30° C.

(8) A process for producing an inkjet recording sheet according to (6) or (7), in which the temperature of the treatment liquid applied before or concurrently with the application of the coating liquid containing the thermosensitive polymeric compound is lower than the thermosensitive point of the thermosensitive polymeric compound by 10° C. or more.

(9) A process for producing an inkjet recording sheet according to any one of (1) to (8), in which an average particle diameter of the inorganic fine particles contained in the ink receiving layer is within a range from 0.01 to 1 μm.

(10) A process for producing an inkjet recording sheet according to (9), in which the fine pigment with an average particle diameter of 0.01 to 1 μm is at least one selected from the group consisting of fumed silica, Mesoporous silica, colloidal material of wet-process silica manufactured by condensing active silicic acid, colloidal silica, alumina oxide, and alumina hydrates.

(11) A process for producing an inkjet recording sheet according to (9) or (10), in which the fine pigment with an average particle diameter of 0.01 to 1 μm is agglomerated particles of a silica-cationic compound treated with a cationic compound.

(12) A process for producing an inkjet recording sheet according to (10), characterized in that a fine alumina oxide with an average particle diameter of 0.01 to 1 μm is vapor-phase-processed alumina fine particles.

(13) A process for producing an inkjet recording sheet according to any one of (1) to (12), in which a porous layer containing inorganic fine particles and a binder as main components thereof is formed between the support and the ink receiving layer, on which the treatment liquid is applied and a coating liquid containing the thermosensitive polymeric compound and the inorganic fine particles is applied.

(14) A process for producing an inkjet recording sheet according to (13), in which the porous layer has peaks in a pore distribution curve within each range of 0.1 to 10 μm and 0.5 μm or less, and a pore volume of 0.5 ml/g or more.

(15) A process for producing an inkjet recording sheet according to any one of (1) to (14), in which after the coating liquid containing the thermosensitive polymeric compound is applied, the resultant material is brought into contact with and pressed against a mirror-finished drum and dried.

(16) A process for producing an inkjet recording sheet according to (15), in which the resultant material is brought into contact with and pressed against a mirror-finished drum simultaneously with the application of the coating liquid containing the thermosensitive polymeric compound or before the coating layer shows a decreased drying rate, and then dried.

(17) A process for producing an inkjet recording sheet according to any one of (1) to (15), in which a coating fluid containing colloidal fine particles as a main component thereof is further applied on the ink receiving layer prepared by drying the coating liquid containing the thermosensitive polymeric compound.

(18) A process for producing an inkjet recording sheet according to (17), characterized in that, concurrently with the further application of the coating fluid containing the colloidal fine particles as a main component thereof onto the ink receiving layer prepared by drying, the coating liquid containing the thermosensitive polymeric compound, the resultant material is brought into contact with and pressed against a mirror-finished drum and then dried.

### EFFECTS OF THE INVENTION

According to the process for producing a coated sheet of the present invention, there can be formed a coating layer simultaneously attaining an ink absorption rate and coating film cracking control suitable for use as an inkjet recording layer, and in particular, there can be realized high gloss, high ink absorption, high printing density, and high image quality (dot roundness) required for use as a glossy inkjet recording sheet.

### BEST MODE FOR CARRYING OUT THE INVENTION

As described above, the present invention relates to a process for producing a coated sheet in which a support or an undercoat layer superimposed on the support is coated with a coating liquid containing a thermosensitive polymeric compound reversibly exhibiting hydrophilicity and hydrophobicity depending on temperature change, characterized in that the coating liquid containing the thermosensitive polymeric compound is applied concurrently with the application of a treatment liquid whose temperature is in the range in which the thermosensitive polymeric compound exhibits hydrophilicity, or after the application of the treatment liquid without drying after the application.

Although it will be explained later, the thermosensitive polymeric compound reversibly exhibiting hydrophilicity and hydrophobicity depending on temperature change refers to a compound that exhibits different properties of hydrophilicity and hydrophobicity in two different temperature ranges depending on a thermosensitive point thereof. Although the process according to the present invention is available for producing general coated sheets, an inkjet recording sheet is expediently used by way of example so as to explain the present invention. Accordingly, the present invention is not limited to a process for producing an inkjet recording sheet.

(With Respect to the Treatment Liquid)

In an aspect of the present invention, it has been found that cracking of a coating film is significantly prevented when drying is carried out after a treatment liquid whose temperature is adjusted to a temperature no higher than a thermosensitive point of the thermosensitive polymeric compound is applied onto a support or an undercoat layer concurrently while or before applying a coating liquid for an ink receiving layer containing the thermosensitive polymeric compound and a pigment at a temperature no lower than the thermosensitive point of the thermosensitive polymeric compound, so that the thermosensitive polymeric compound contained in the coating liquid for the ink receiving layer is thickened or gelatinized (hereinafter, may be referred to as thickening or gelatinization) at the time of application. Although the reason for this is not clear, it is presumed that, for example, when the coating liquid for the ink receiving layer is cooled after the application, the coating liquid is thickened or gelatinized, but the degree of thickening or gelatinization of the inside of the coating liquid or the interface between the support and the undercoat layer is lower than that of the surface of the coating liquid, and so the effects of preventing the occurrence of cracking are very high. According to the present invention, the temperature of the coating liquid at the support or undercoat layer side portion is lowered in advance by applying the treatment liquid, and so the degree of thickening or gelatinization at the portion becomes extremely high. Moreover, when the ink receiving layer containing the thermosensitive polymeric compound is formed by being brought into contact with and pressed against a heated mirror-finished drum while a wet state remains and then separated therefrom after thickening or gelatinizing according to the present invention for the purpose of increasing its glossiness, high glossiness may be further easily realized.

In particular, the occurrence of cracking can be significantly prevented when the temperature of treatment liquid to be applied is lower than the thermosensitive point of the thermosensitive polymeric compound by 10° C. or more. Although a solvent of the coating material is not particularly limited, it is preferable that the solvent be water due to its ease of use. By making the treatment liquid contain a cationic polymer or a water-soluble polyvalent metal salt, the treatment liquid infiltrates into the support or the undercoat layer at the time of application, and the water resistance and heat-moisture-exudation resistance are significantly improved.

In the present invention, it is preferable that a wet-on-wet method in which the coating liquid containing the thermosensitive polymeric compound is applied while the treatment liquid whose temperature is no higher than the thermosensitive point is not dried be used.

Examples of substances that enable gelatinization depending on temperature change without containing any gelatinizing agents include thermosensitive polymeric compounds that exhibit hydrophobicity at a temperature no higher than the thermosensitive point but exhibit hydrophilicity at a temperature no lower than the thermosensitive point, as disclosed in Japanese Patent Application, First Publication No. H 8-244334, in addition to the above. When such compounds are used, the effects of the present invention can be exhibited by applying a treatment liquid whose temperature is no lower than the thermosensitive point on the support or the undercoat layer concurrently while or before applying the coating liquid that forms an ink receiving layer at a temperature no higher than the thermosensitive point.

(With Respect to the Support)

The support used in the present invention is not particularly limited, provided that the support is a known sheet support. For example, films such as cellophane, polyethylene, polypropylene, soft polyvinyl chloride, rigid polyvinyl chloride, polyester, or the like, sheet base materials such as polyolefin-laminated paper (such as polyethylene-laminated paper), metal foil, metal leaf, synthetic paper, non-woven fabric, or the like, may be suitably used as non-air-permeable base materials. On the other hand, paper base materials such as wood-free paper, art paper, coat paper, cast-coated paper, foil paper, kraft paper, baryta paper, paper board, impregnated paper, metallized paper, water-soluble paper, or the like, may be suitably used as air-permeable base materials.

When the support is used for an inkjet recording sheet, the above-mentioned non-air-permeable base materials and air-permeable base materials may be suitably used. However, among these, the paper base materials such as art paper, coat paper, thick high density base paper, baryta paper, or the like, and polyethylene-laminated paper (in particular, paper coated with polyethylene resin kneaded with titanium oxide, which is so-called RC paper), synthetic paper, or the like, are preferably used so as to produce a recording sheet with photographic tone.

The paper base materials are mainly composed of wood pulp and a filler which is contained as needed.

As the wood pulp, various chemical pulps, mechanical pulps, recycled pulps, or the like, may be used. The beating degree of these pulps may be adjusted using a beating machine so as to adjust the paper strength, papermaking suitability, or the like. The beating degree (freeness) of the pulp is not particularly limited, but is generally approximately 250 to 550 ml (CSF: JIS-P-8121). Although a higher beating degree is preferable to improve the smoothness, there are many cases in which a lower beating degree provides more favorable results in terms of roughness of the sheet or bleeding of recorded images caused by moisture contained in the ink. Accordingly, the freeness is preferably approximately 300 to 500 ml.

The filler is formulated so as to provide opaqueness or adjust the ink absorbability thereof, and examples thereof include calcium carbonate, baked kaolin, silica, titanium oxide, plastic pigment, and the like. In particular, calcium carbonate is preferably used so as to enhance the whiteness degree of a base material and thus calcium carbonate is preferable. When calcium carbonate is formulated as the filler to produce a paper base material for an inkjet recording sheet, the glossiness of the recording sheet increases, and thus calcium carbonate is preferably used. Moreover, since baked kaolin, silica, or zeolite formulated as the filler absorbs the solvent contained in the inkjet ink, they are preferably used.

It is preferable that the content of the filler contained in the paper base material (ash content) be approximately 1 to 20%, When the content is extremely high, there is a possibility of the paper strength decreasing. When the content is extremely low, the air-permeability of the paper base material deteriorates. Accordingly, the preferable content of the filler is 7 to 20%. When the content is within this range, the smoothness, permeability, and paper strength are balanced, and thereby inkjet recording sheets with excellent glossiness can be easily produced.

To the paper base material, a sizing agent, a fixing agent, a paper-reinforcing agent, a cationizing agent, yield-improving agent, a dye, a fluorescent whitening agent, or the like, may be added as an auxiliary agent. Moreover, the surface strength, sing degree, or the like, may be adjusted in a size press process of a paper making machine by applying or impregnating a starch, a polyvinyl alcohol, a cationic resin, or the like. It is preferable that the Stoeckigt sizing degree (measured in accordance with JIS-P-8122 as 100 g/m² paper) be approximately 1 to 250 seconds. When the sizing degree is low, there may be problems in terms of operation such as generation of wrinkles at the time of application. When the sizing degree is high, there are cases in which the ink absorption decreases and curling or cockling occurs significantly after printing. The more preferable sizing degree is within a range from 4 to 230 seconds, and even more preferably is 30 to 210 seconds. Although the base weight of the base material is not particularly limited, the base weight is approximately 20˜400 g/m², preferably 150 to 250 g/m², and even more preferably 175 to 230 g/m². For example, paper such as wood-free paper, art paper, coat paper, cast-coated paper, kraft paper, baryta paper, impregnated paper, metallized paper, water-soluble paper, or the like, are suitably used.

When the coated sheet is finished so as to have a high gloss by bringing it into contact with and pressing it against a heated mirror-finished drum while the uppermost layer thereof is in a wet state, and preferably followed by drying, an air-permeable base material is preferably used. The air-permeable base material is not particularly limited, provided that it is a base material having air-permeability. As the air-permeable base material, paper base materials such as acid paper, neutralized paper, or other paper generally used for coated paper, are suitably used. Also, resin sheets or non-woven fabric with air-permeability may be used.

It is preferable that the permeability of the air-permeable base material (JIS-P-8117) be approximately 20 to 500 seconds, and more preferably 35 to 300 seconds. When the permeability is lower than 20 seconds, an obtained inkjet recording sheet tends to have high roughness on the surface thereof, and lacks a glossy appearance. On the other hand, when the permeability is larger than 500 seconds, adhesiveness of the sheet to the mirror-finished drum with which the sheet is brought into contact deteriorates, and the uppermost layer cannot be sufficiently dried, and thereby it tends to become difficult to realize a high surface glossiness.

As the non-air-permeable support, a resin film, non-woven fabric, resin-coated paper such as one in which a resin film is adhered via an adhesive on a coat paper, wood-free paper, or the like, one in which a resin is laminated on paper, or the like, way be used. Among these, use of the resin film or paper laminated with resin is suitable for realizing excellent water resistance.

Examples of the resin film include thermoplastic resins such as a polyester resin, an olefin resin, nylon, and the like. Examples of the polyester resin include polyethylene terephthalate, polybutylene terephthalate, polycyclohexene terephthalate, and the like. Examples of the olefin resin include ones composed of polyethylene, polypropylene, ethylene-propylene copolymer, or ethylene vinyl acetate copolymer, ones containing these as the main component thereof, and the like. At least one of these thermoplastic resins may be suitably selected for use, and may be used in combination with other thermoplastic resins such as polystyrenes, acrylic acid ester copolymers, or the like.

Films formed by stretching these thermoplastic resins in a longitudinal direction and/or lateral direction may be used. In addition to these, inorganic fine powders may be mixed with the thermoplastic resin to form a film, and the film may be, for example, uniaxially stretched or biaxially stretched to form a papyraceous layer. In the present invention, such films may be multiply laminated to form a multilayer film for use as the support, and, for example, a bilayer or three-layered film having a base material layer and (a) papyraceous layer(s) disposed on both surfaces or one surface thereof, a three- to five-layered film further having at least a surface layer disposed on at least one surface of the former film, or the like, may be used. Thus, ones including the thermoplastic resin as the papyraceous layer are generally known as synthetic papers.

Examples of paper laminated with resin include paper laminated with thermoplastic resin by extrusion, and examples of the thermoplastic resin include polyolefin resins such as polypropylene, polyethylene, and the like, and polyester resins. In the thermoplastic resin, pigments such as titanium dioxide, dyes, ultraviolet absorbers, or the like, may be suitably formulated.

The support may be suitably selected from the above-mentioned supports in accordance with a method for forming a coating layer formed thereon or a usage purpose thereof. It is apparent that the color of the support may be adjusted using a fluorescent dye, a fluorescent pigment or the like, an antistatic layer, an anchor layer, or a barrier layer may be laminated thereon, and corona discharge treatment may be carried out.

(With Respect to the Undercoat Layer)

The undercoat layer formed on the support as needed is not particularly limited provided that it is a layer containing a pigment and an adhesive. Since the treatment liquid is applied before or concurrently with application of the coating liquid containing the thermosensitive polymeric compound, it is preferable that the undercoat layer be superimposed on the support so as to retain the treatment liquid when the above-mentioned non-air-permeable support is used. Also, when the air-permeable support is used, the undercoat layer may be formed.

The content ratio of the adhesive to the pigment in the undercoat layer is, although it depends on the kind thereof, generally adjusted to be within a range from 1 to 200 parts by mass, and preferably 2 to 100 parts by mass, with respect to 100 parts by mass of the pigment. Moreover, various auxiliary agents generally used for manufacturing coated sheets, such as a dispersing agent, a thickening agent, an antifoam agent, an antistatic agent, a preservative agent, or the like, may be suitably added. Also, a fluorescent dye and/or a coloring agent may be contained in the undercoat layer. The undercoat layer is formed on the paper base material in a dry mass of 2 to 100 g/m², preferably 5 to 50 g/m², and more preferably 10 to 20 g/m².

Moreover, in the case of an inkjet recording sheet, the undercoat layer may be provided with a function of rapidly absorbing a solvent contained in components of an inkjet ink. Such an undercoat layer contains a pigment and an adhesive as the main components thereof. Although there are no problems when the undercoat layer is a layer containing an extremely fine pigment with an average particle diameter of less than 0.5 μm and an adhesive that does not crack, a pigment with an average particle diameter of 0.5 μm to 10 μm and an adhesive are preferably used. Such a layer containing the pigment with an average particle diameter of 0.5 μM to 10 μm and the adhesive exhibits a rapid ink absorption rate. In order to rapidly separate a solvent and dye contained in ink components, it is preferable that the layer have peaks in a pore distribution curve within each range of 0.1 to 10 μm and 0.5 μm or lower, and a pore volume of 0.5 ml/g or more.

As the pigment contained in the undercoat layer, at least one of various pigments well known and conventionally used for manufacturing general coated sheets, such as a kaolin, clay, baked clay, noncrystalline silica (alternatively, referred to as amorphous silica), synthesized noncrystalline silica, zinc oxide, aluminum oxide, aluminum hydroxide, calcium carbonate, Satin White, aluminum silicate, alumina, colloidal silica, zeolite, synthesized zeolite, sepiolite, smectite, a synthesized smectite, magnesium silicate, magnesium carbonate, magnesium oxide, diatomaceous earth, a styrene-based plastic pigment, hydrotalcite, a urea resin-based plastic pigment, a benzoguanamine-based plastic pigment, and the like, may be used alone or in combination. Among these, it is preferable that amorphous silica, alumina, or zeolite be contained as the main component due to their high ink absorbability.

It is preferable that these pigments have an average particle diameter (alternatively, an average agglomerated particle diameter in the case of agglomerated pigments) of approximately 0.5 to 10 μm, and more preferably 1 to 5 μm. When the diameter is less than 0.5 μm, the effects of improving the ink absorption rate deteriorate. When the diameter is larger than 10 μm, there is a possibility that the smoothness or glossiness becomes insufficient after forming a glossy layer. It is possible for pigments with different average particle diameters to be used in combination with each other.

In order to adjust the ink absorption rate and prevent penetration of the coating liquid applied on the undercoat layer, a pigment with a small average particle diameter may be formulated as subingredient. As such a pigment, colloidal silica or alumina sol may be used.

As the adhesive contained in the undercoat layer, adhesives conventionally known and generally used for manufacturing coated sheets, such as proteins such as caseins, soy proteins, synthesized proteins, or the like, various starches such as starches, oxidized starches, or the like, polyvinyl alcohols such as polyvinyl alcohol, modified polyvinyl alcohols such as cationic polyvinyl alcohols, silyl-modified polyvinyl alcohols, or the like, cellulose derivatives such as carboxymethylcellulose, methylcellulose, or the like, conjugated diene-based polymer latexes such as styrene-butadiene copolymers, or methyl methacrylate-butadiene copolymers, acrylic polymer latexes, vinyl-based polymer latexes such as ethylene-vinyl acetate copolymers, or the like, may be used alone or in combination.

The formulation ratio of the adhesive to the pigment in the undercoat layer is, although the ratio depends on the kind thereof, generally adjusted to be within a range from 1 to 100 parts by mass, and preferably 2 to 50 parts by mass, with respect to 100 parts by mass of the pigment. Moreover, various auxiliary agents generally used for manufacturing a coated sheet, such as a dispersing agent, a thickening agent, an antifoam agent, an antistatic agent, a preservative agent, or the like, may be suitably formulated. Also, a fluorescent dye or a coloring agent may be formulated in the undercoat layer.

It is preferable that substantially no cationic compound exist in the undercoat layer. The phrase “substantially no cationic compound exist” excludes the case in which a cationic surfactant, or the like, is added in an extremely small amount as an auxiliary agent. When a cationic compound is contained in the coating layer superimposed on the undercoat layer substantially free from the cationic compound, extremely excellent glossiness is realized and the printing density is enhanced, and thus such an aspect is preferable.

The solid concentration of a coating fluid for the undercoat layer prepared from the above-mentioned materials is generally adjusted to approximately 5 to 50% by mass, and the coating fluid is generally applied on the paper base material in a dry mass of 2 to 100 g/m², preferably about 5 to 50 g/m², and more preferably about 10 to 20 g/m². When the coating amount is small, there are possibilities in which effects for improving ink absorption are not sufficiently exhibited or the glossiness of the obtained inkjet recording coated sheets is insufficient. When the coating amount is high, there are cases in which the printing density deteriorates, the strength of the coating layer superimposed thereon deteriorates, or powdering or scratching easily occurs.

The coating fluid for the undercoat layer may be applied and dried using various known coating devices, such as a blade coater, an air-knife coater, a roll coater, a brush coater, a champflex coater, a bar coater, a lip coater, a gravure coater, a curtain coater, a slot die coater, a slide coater, or the like. Moreover, the undercoat layer may be subjected to a smoothing treatment such as super calender, brushing, or the like, as needed.

(With Respect to the Coating Layer)

In the present invention, the coating layer is formed by applying the coating liquid containing the thermosensitive polymeric compound concurrently with or after the application of the treatment liquid on the support or the undercoat layer. In the case of an inkjet recording sheet, the coating layer containing the pigment and the thermosensitive polymeric compound forms an ink receiving layer or one layer composing the ink receiving layer (hereinafter, both are referred to as an ink receiving layer).

The thermosensitive polymeric compound is a compound reversibly exhibiting hydrophilicity and hydrophobicity depending on temperature change. Among these, it is preferable that the thermosensitive polymeric compound be one that is rapidly thickened or gelatinized when the temperature thereof reaches no higher than the thermosensitive point thereof. Specific examples thereof include thermosensitive polymeric compounds that exhibit hydrophilicity at a temperature no higher than the thermosensitive point thereof, but exhibit hydrophobicity at a temperature no lower than the thermosensitive point thereof, and the like. When such a thermosensitive polymeric compound is used, application thereof is generally carried out at a temperature no lower than the thermosensitive point thereof. It is preferable that the thermosensitive point of the thermosensitive polymeric compound be within a range from 5 to 35° C., and more preferably 15 to 30° C.

Such thermosensitive polymeric compounds have been disclosed in Japanese Patent Application, First Publication No. 2003-40916. Examples thereof include thermosensitive polymeric compounds obtained by polymerization in the coexistence of polyvinyl alcohols and/or polyvinyl alcohol derivatives.

Such thermosensitive polymeric compounds are specifically as follows: (1) polymeric compounds obtained by polymerizing in the coexistence of polyvinyl alcohols and/or polyvinyl alcohol derivatives at least one kind of monomer that can produce polymeric compounds exhibiting temperature-response (change between hydrophilicity and hydrophobicity) by homopolymerization (main monomer (M)); or (2) polymeric compounds obtained by polymerizing in the coexistence of polyvinyl alcohols and/or polyvinyl alcohol derivatives the maim monomer (M) and a monomer that can produce polymeric compounds by reaction with the main monomer (M) but cannot produce the polymeric compounds exhibiting temperature-response by homopolymerization (submonomers (N)).

It becomes possible to produce polymeric compounds with different thermosensitive points or film formation properties by using the submonomers (N) as copolymerization components.

Each main monomer (M), submonomer (N), polyvinyl alcohol, and polyvinyl alcohol derivative may be used alone or in combination of two or more kinds thereof.

When the polymeric compound prepared by polymerizing either the main monomer (M) or the combination of the main monomer (M) and submonomer (N) in the coexistence of polyvinyl alcohols and/or derivatives thereof is used as the thermosensitive polymeric compound, a coated sheet including a coating layer can be prepared, which has film formation properties and film strength, both of which are superior to those of a polymeric compound prepared in the same manner except that polymerization is carried out in the absence of polyvinyl alcohols and/or derivatives thereof.

The polyvinyl alcohols and/or polyvinyl alcohol derivatives used in the present invention are not particularly limited.

Examples of the polyvinyl alcohols include polyvinyl alcohols with a saponification degree of 96% to 100%, such polyvinyl alcohols being generally referred to as complete saponification-type polyvinyl alcohols, polyvinyl alcohols with a saponification degree of 76% to 95%, such polyvinyl alcohols being generally referred to as partial saponification-type polyvinyl alcohols, and the like.

Examples of the polyvinyl alcohol derivatives include silanol-modified polyvinyl alcohols, cation-modified polyvinyl alcohols, mercapto group-containing polyvinyl alcohols, keto group-containing polyvinyl alcohols, and the like.

The polyvinyl alcohols and/or the polyvinyl alcohol derivatives may be used alone or in combination with plural kinds thereof.

Although the polymerization degrees of the polyvinyl alcohols and the polyvinyl alcohol derivatives are not particularly limited, ones with a polymerization degree of 300 to 4000 are preferably used.

Moreover, it is preferable from the standpoint of the ink absorption that the keto group-containing polyvinyl alcohol is used together with a hydrazine derivative having at least two groups of a hydrazine group or groups and a semicarbazide group or groups as described below so as to crosslink the keto group.

The ratio of the main monomer (M), submonomer (N), polyvinyl alcohol, and/or polyvinyl alcohol derivative for use may be determined within a range in which an obtained thermosensitive polymeric compound exhibits temperature-response. Although the content ratio of the polyvinyl alcohol or polyvinyl alcohol derivative in the thermosensitive polymeric compound is not particularly limited provided that the content ratio is within the range complying with the above-mentioned condition, it is preferable from the standpoint of water resistance of a coating film of a finally obtained recording medium that the content ratio be 0.1 to 50% by mass, and more preferably 0.5 to 20% by mass.

Examples of the main monomer (M) include N-alkyl- or N-alkylene-substituted (meth)acrylamide derivatives (herein, the term “(meth)acryl” is an abbreviation of methacryl (or methacryl) and acryl), vinylmethylethers, and the like, and specific examples thereof include N-ethyl (meth)acrylamide, N-isopropyl (meth)acrylamide, N-cyclopropyl (meth)acrylamide, N-ethyl (meth)acrylamide, N,N-diethyl acrylamide, N,N-dimethyl (meth)acrylamide, N-n-propyl (meth)acrylamide, N-methyl-N-n-propyl acrylamide, N-methyl-N-isopropyl acrylamide, N-(meth)acryloyl pyrrolidine, N-(meth)acryloyl piperidine, N-tetrahydrofurfuryl (meth)acrylamide, N-methoxypropyl (meth)acrylamide, N-ethoxypropyl (meth)acrylamide, N-isopropoxypropyl (meth)acrylamide, N-ethoxyethyl (meth)acrylamide, N-(2,2-dimethoxyethyl)-N-methyl acrylamide, N-methoxyethyl (meth)acrylamide, N-(meth)acryloyl morpholine, and the like. From the standpoint of film formation properties, N-isopropyl acrylamide, N-n-propyl acrylamide, N,N-diethyl acrylamide, and N-acryloyl morpholine are preferable.

Examples of the submonomer (N) include oleophilic vinyl compounds, hydrophilic vinyl compounds, ionic vinyl compounds, and the like. Specific examples of the oleophilic vinyl compounds include methyl (meth)acrylate, ethyl (meth)acrylate, n-butyl (meth)acrylate, 2-ethylhexyl (meth)acrylate, glycidyl methacrylate, styrene, α-methylstyrene, ethylene, isoprene, butadiene, vinyl acetate, vinyl chloride, and the like. Specific examples of the hydrophilic vinyl compounds include 2-hydroxyethyl (meth)acrylate, 2-hydroxypropyl (meth)acrylate, (meth)acrylamide, N-methylol acrylamide, diacetone acrylamide, methylenebis acrylamide, 2-methyl-5-vinylpyridine, N-vinyl-2-pyrrolidone, N-acryloyl pyrrolidine, and the like. Specific examples of the ionic vinyl compounds include carboxylic group-containing monomers such as acrylic acid, methacrylic acid, itaconic acid, fumaric acid, maleic acid, crotonic acid, butenetricarboxylic acid, monoethyl maleate, monomethyl maleate, monoethyl itaconate, monomethyl itacorate, and the like, sulfonic group-containing monomers such as 2-acrylamide-2-methyl-propanesulfonic acid, styrenesulfonic acid, vinylsulfonic acid, (meth)acrylsulfonic acid, and the like, amino group-containing monomers such as N,N-dimethylaminoethyl (meth)acrylate, N,N-diethylaminoethyl (meth)acrylate, and the like. In particular, methyl (meth)acrylate, n-butyl (meth)acrylate, 2-ethylhexyl (meth)acrylate, styrene, 2-hydroxypropyl (meth)acrylate, acrylamide, methacrylamide, diacetone acrylamide, methylene bisacrylamide are preferably used. From the standpoint of film formation properties of a coating layer formed using a polymer emulsion according to the present invention, anionic group-containing monomers such as the carboxylic group-containing monomers such as acrylic acid, methacrylic acid, itaconic acid, fumaric acid, maleic acid, crotonic acid, butenetricarboxylic acid, monoethyl maleate, monomethyl maleate, monoethyl itaconate, monomethyl itaconate, and the like, the sulfonic group-containing monomers such as 2-acrylamide-2-methyl-propanesulfonic acid, styrenesulfonic acid, vinylsulfonic acid, (meth)acrylsulfonic acid, and the like, are preferably used, and, in particular, the carboxylic group-containing monomers such as acrylic acid, methacrylic acid, itaconic acid, fumaric acid, maleic acid, and the like are preferably used.

The copolymerization ratio of the main monomer (M) and the submonomer (N) are determined within a range in which an obtained copolymerized polymeric compound exhibits temperature-response in which the hydrophilicity and the hydrophobicity thereof are reversibly changed from one to the other at a constant temperature as a borderline. That is, when the ratio of the submonomer (N) is extremely high, the obtained copolymerized polymeric compound does not exhibit the temperature-response. That is, although the copolymerization ratio of the main monomer (M) and the submonomer (N) depends on the combination of the kinds of monomers used, it is preferable that the ratio of the submonomer (N) in the obtained thermosensitive polymeric compound be 50% by mass or lower, and more preferably 30% by mass or lower. On the other hand, it is preferable that the ratio of the submonomer (N) be 0.01% by mass or more so as to effectively realize its effect.

In the case of an inkjet recording sheet, although a cationic compound described below tends to be formulated in the coating layer (ink receiving layer), it is preferable that the thermosensitive polymeric compound be cationic or nonionic because preparation of the coating liquid becomes easier in this aspect.

The cationic thermosensitive polymeric compound can be produced, for example, by making an ethylenically unsaturated monomer having a cationic group contained as the submonomer (N) used for polymerization, and from this standpoint it is preferable that at least one kind of ethylenically unsaturated monomers be used as the submonomer (N). The ethylenically unsaturated monomers having a cationic group may be used alone or in combination of two or more kinds thereof. In particular, it is more preferable that the ethylenically unsaturated monomer having a cationic group contains a tertiary amino group and/or quaternary ammonium base from the standpoint of discoloring degree occurring in matter printed on an obtained recording medium using an inkjet printer when the printed matter is exposed to sunlight or fluorescent light, and from the standpoint of colloidal stability of an obtained polymer emulsion.

The thermosensitive polymeric compound containing a tertiary amino group and/or quaternary ammonium base can be produced, for example, by copolymerizing the main monomer (M) and the monomer containing a tertiary amino group and/or quaternary ammonium base used as the submonomer (N). The main monomer (M) and the submonomer (N) (including the monomer containing a tertiary amino group and/or quaternary ammonium base) may be used alone or in combination of two or more kinds thereof.

The monomer containing a tertiary amino group or quaternary ammonium base is not particularly limited, provided that the monomer has a structure in which a tertiary amino group or quaternary ammonium base is contained in the monomer, and examples thereof include vinyloxy ethyl trimethyl ammonium chloride, 2,3-dimethyl-1-vinyl imidazolynium chloride, trimethyl-(3-(meth)acrylamide-3,3-dimethylpropyl) ammonium chloride, trimethyl-3-methacrylamidepropyl) ammonium chloride, trimethyl-(3-acrylamidepropyl) ammonium chloride, N-(1,1-dimethyl-3-dimethylaminopropyl) (meth)acrylamide, and quaternary ammonium salts thereof, trimethyl-(3-meth)acrylamide) ammonium chloride, 1-vinyl-2-methyl-imidazole, 1-vinyl-2-ethyl-imidazole, 1-vinyl-2-phenyl-imidazole, 1-vinyl-2,4,5-trimethyl-imidazole, N,N-dimethylaminopropyl (meth)acrylate, and quaternary ammonium salts thereof, N,N-dimethylaminoethyl (meth)acrylate, and quaternary ammonium salts thereof, N,N-diethylaminoethyl (meth)acrylate, and quaternary ammonium salts thereof, t-butylaminoethyl (meth)acrylate, and quaternary ammonium salts thereof, N-(3-dimethylaminopropyl) methacrylamide, and quaternary ammonium salts thereof, N-(3-dimethylaminopropyl) acrylamide, and quaternary ammonium salts thereof, N-(3-diethylaminopropyl) methacrylamide, and quaternary ammonium salts thereof, N-(3-diethylaminopropyl) acrylamide, and quaternary ammonium salts thereof, o-, m-, p-aminostyrene, and quaternary ammonium salts thereof, o-, m-, p-vinylbenzylamine, and quaternary ammonium salts thereof, N-(vinylbenzyl) pyrrolidone, N-(vinylbenzyl)piperidine, N-vinylimidazole, and quaternary ammonium salts thereof, 2-methyl-1-vinylimidazole, and quaternary ammonium salts thereof, N-vinylpyrrolidone, and quaternary ammonium salts thereof, N,N′-divinylethyleneurea, and quaternary ammonium salts thereof, α-, or β-vinylpyridine, and quaternary ammonium salts thereof, α-, or β-vinylpiperidine, and quaternary ammonium salts thereof, 2-, or 4-vinylquinoline, and quaternary ammonium salts thereof, and the like. In particular, methylchloride quaternary compounds of N,N-dimethylaminopropyl methacrylate, N,N-dimethylaminoethyl methacrylate, and N,N-dimethylaminopropyl (meth)acrylamide are preferably used.

The copolymerization ratio of the main monomer (M) and the submonomer (N) including the monomer containing a tertiary amino group and/or quaternary ammonium base is determined within a range in which an obtained copolymerized polymeric compound exhibits temperature-response in which the hydrophilicity and the hydrophobicity thereof are reversibly changed from one to the other at a constant temperature as a borderline. Although the content ratio of the monomer unit containing a tertiary amino group and/or quaternary ammonium base in the thermosensitive polymeric compound used in the present invention is not particularly limited provided that the ratio is within the above-mentioned range, it is preferable that the ratio be 0.01% by mass or more from the standpoint of ease of preparation of the coating liquid, but be 50% by mass or smaller from the standpoint of film formation properties. It is more preferable that the ratio be 0.1 to 30% by mass.

Moreover, use of the monomer containing a quaternary ammonium base is more preferable than use of the monomer containing a tertiary amino group from the standpoint of discoloring degree occurring in printed matter exposed to sunlight or fluorescent light. Moreover, it is preferable that the monomer containing a tertiary amino group and/or quaternary ammonium base be contained together with the anionic group-containing monomer from both the standpoints of ease of preparation of the coating liquid and film formation properties of the coating layer formed using the polymer emulsion according to the present invention. In particular, it is preferable that the carboxylic group-containing monomers such as acrylic acid, methacrylic acid, itaconic acid, fumaric acid, maleic acid, or the like be used as the anionic group-containing monomer.

Next, an inorganic pigment contained in the coating layer (ink receiving layer) in the case of an inkjet recording sheet will be explained in detail.

Examples of the available pigment include a kaolin, clay, baked clay, noncrystalline silica (alternatively, referred to as amorphous silica), synthesized noncrystalline silica, zinc oxide, aluminum oxide, aluminum hydroxide, calcium carbonate, Satin White, aluminum silicate, alumina, colloidal silica, zeolite, a synthesized zeolite, sepiolite, smectite, a synthesized smectite, magnesium silicate, magnesium carbonate, magnesium oxide, diatomaceous earth, a styrene-based plastic pigment, hydrotalcite, a urea resin-based plastic pigment, a benzoguanamine-based plastic pigment, and the like, and these may be used alone or in combination of two or more kinds thereof.

As the silica, dispersion liquids of silica fine particles in which the silica fine particles with 100 m²/g to 400 m²/g specific surface area measured by a nitrogen adsorption method, 20 nm to 300 nm average secondary particle diameter; and 0.5 ml/g to 2.0 ml/g pore volume are dispersed in a colloidal state by gradually adding a feed liquid containing an active silicate aqueous solution and/or an alkoxysilane in the presence of an alkali to a feed liquid in which silica fine particles with 300 m²/g to 1000 m²/g specific surface area and 0.4 ml/g to 2.0 ml/g pore volume are dispersed in a colloidal state so as to grow silica fine particles may be used.

Among these, extremely fine pigments with an average primary particle diameter of 3 to 40 nm and an average secondary particle diameter of 1000 nm or smaller may be preferably used. Ones having an average primary particle diameter of 5 to 30 nm and an average secondary particle diameter of 700 nm or smaller are more preferable. In particular, finned silicas, alumina oxides, and alumina hydrates are preferable, and dry silicas cationized using cationic resins are particularly preferable.

It is preferable that the content of the thermosensitive polymeric compound in the coating layer (ink receiving layer) be within a range from 1 to 100 parts by mass, more preferably 5 to 40 parts by mass, and even more preferably 15 to 30 parts by mass, with respect to 100 parts by mass of the pigment. When the content of the thermosensitive polymeric compound is less than 1 part by mass, the coating liquid tends to be insufficiently gelatinized, and the glossiness and the ink dot roundness tend to deteriorate. On the other hand, when the content of the thermosensitive polymeric compound is more than 100 parts by mass, there is a case in which the ink absorption deteriorates and a desired inkjet recording suitability is not realized.

In the coating layer (ink receiving layer), well-known cationic compounds may be formulated. For example, 1) polyalkylene polyamines such as polyethylene polyamine or polypropylene polyamine, and derivatives thereof, 2) acrylic polymers having a secondary amino group, tertiary amino group, or quaternary ammonium group, 3) polyvinylamines and polyvinylamines, 4) dicyan-based cationic compounds exemplified by dicyandiamide-formalin copolymers, 5) polyamine-based cationic compounds exemplified by dicyandiamide-polyethyleneamine copolymers, 6) epichlorohydrin-dimethylamine copolymers, 7) diallyldimethyl ammonium-SO₂ polycondensation products, 8) diallylamine salt-SO₂ polycondensation products, 9) diallyldimethyl ammonium chloride polymers, 10) diallyldimethyl ammonium chloride-acrylamide copolymers, 11) copolymers of allylamine salts, 12) dialkylaminoethyl (meth)acrylate quaternary salt copolymers, 13) acrylamide-diallylamine copolymers, 14) cationic compounds such as cationic resins having a five-membered amidine structure, and the like, can be exemplified.

It is preferable that the mass ratio of the cationic compound to the pigment be 1 to 30 parts by mass, and more preferably 3 to 20 parts by mass, with respect to 100 parts by mass of the pigment. When the ratio of the cationic compound is smaller than 1 part by mass, it becomes difficult for effects of improving printing density to be exhibited. When the ratio is more than 30 parts by mass, excessive cationic compounds tend to cover vacant spaces, and thereby there are possibilities in which the ink absorption deteriorates and so bleeding or unevenness occurs in the image.

Although the cationic compound may be mixed with the pigment so as to be contained in the pigment, when the pigment is a fine silica, in particular, the fine silica being generally anionic, there is a case in which particles contained in the fine silica are agglomerated at the time of mixing.

In this case, the particle diameter can be adjusted to the above-mentioned particular particle diameter by mixing and dispersing a noncrystalline silica commercially available in general (having a secondary particle diameter of a few microns) together with a cationic substance and then applying a strong force to the dispersion mixture using a mechanical apparatus to pulverize and disperse the mixture to a fine particle dispersion, or by mixing a cationic substance with a dispersion of finely divided silica secondary particles, and thickening and agglomerating the mixture, followed by carrying out mechanical dispersion and pulverization again. The pigment treated in such a way has a structure in which the cationic substance is partially bonded, and stably dispersed to form a slurry, and so have a characteristic that hardly aggregates even when another cationic compound is further added. In the specification, such fine pigments treated with the cationic substance are referred to as cationic fine pigments.

For the purpose of dispersing or pulverizing the mixture of the pigment and the cationic substance or the agglomerated matter thereof, a homomixer, a pressure-type homogenizer, an ultrasonic homogenizer, a microfluidizer, an ultimaizer system, a nanomizer, a rapidly rotating mill, a roller mill, a container driven medium mill, a medium stirring mill, a jet mill, a sand grinder, a Crea Mix, or the like, may be used.

When the average secondary particle diameter exceeds 1000 nm, the mixture can be sufficiently dispersed by application of weak mechanical force using a homomixer, or the like. For the purpose of pulverizing the mixture to particles with an average secondary particle diameter of 1000 nm or smaller, application of a stronger mechanical force is effective, and a pressure-type dispersion method is preferably used.

In the present specification, the pressure-type dispersion method is a method in which a slurry mixture of raw particulate materials is pulverized at a high pressure by continuously passing the mixture through an orifice at a high pressure, the treatment pressure being 19.6×10⁶ to 343.2×10⁶ Pa (200 to 3500 kgf/cm²), more preferably 49.0×10⁶˜245.3×10⁶ Pa (500 to 2500 kgf/cm²), and even more preferably 98.1×10⁶ to 196.2×10⁶ Pa (1000 to 2000 kgf/cm²). The above-mentioned treatment of high-pressure pulverization enables favorable dispersion or pulverization. A method for dispersion or pulverization in which the slurry mixture passed through the orifice at a high pressure is further made to collide head-on is more preferable. In a method for making the slurry mixture collide head-on, the dispersion is pressurized to direct it to an inlet side and divide it to flow into two passages, the flow rates thereof being enhanced by narrowing the flow passages using the orifice, and thus the dispersion is made to collide head-on so that particles are made to collide to pulverize them. As a material used for forming a portion in which the dispersion is accelerated or made to collide, diamond is preferably used due to its abrasion resistance or the like.

As a high pressure pulverizer, a pressure-type homogenizer, an ultrasonic homogenizer, a microfluidizer, or a nanomizer may be used, and the microfluidizer and the nanomizer are particularly preferable as a high speed colliding type homogenizer.

The cationic fine pigments subjected to such a treatment are generally obtained as an aqueous dispersion (a slurry or colloidal particles) with a solid concentration of approximately 5 to 20% by mass.

In this specification, the average particle diameter is a particle diameter measured by observing a sample using an electron microscope (SEM and TEM) (taking an electron micrograph enlarged by ten thousand to four hundred thousand times, and measuring and averaging the Martin diameter of particles within 5 square centimeters) (refer to “Fine powder handbook” (Asakura-shoten), p. 52, 1991).

When an ink receiving layer containing such a cationic fine pigment is formed, ink is further uniformly absorbed, and thereby uniform color with less bleeding can be realized, and an excellent image without uneven development can be formed. As a pigment contained in the cationic fine pigment, silica or alumino silicate is preferable, silica is more preferable, and dry silica is even more preferable.

The cationic substance used in the cationic fine pigment is not particularly limited, and examples thereof include 1) polyalkylene polyamines such as polyethylene polyamine or polypropylene polyamine, and derivatives thereof, 2) acrylic polymers having a secondary amino group, tertiary amino group, or quaternary ammonium group, 3) polyvinylamines and polyvinylamidines, 4) dicyan-based cationic compounds exemplified by dicyandiamide-formalin copolymers, 5) polyamine-based cationic compounds exemplified by dicyandiamide-polyethyleneamine copolymers, 6) epichlorohydrin-dimethylamine copolymers, 7) diallyldimethyl ammonium-SO₂ polycondensation products, 8) diallylamine salt-SO₂ polycondensation products, 9) diallyldimethyl ammonium chloride polymers, 10) diallyldimethyl ammonium chloride-acrylamide copolymers, 11) copolymers of allylamine salts, 12) dialkylaminoethyl (meth)acrylate quaternary salt copolymers, 13) acrylamide-diallylamine copolymers, 14) cationic compounds such as cationic resins having a five-membered amidine structure.

Among these, it is preferable that at least one selected from the group consisting of diallyldimethyl ammonium chloride polymers, diallyldimethyl ammonium chloride-acrylamide copolymers, hydrochloride salts of acrylamide-diallylamine copolymers, dicyandiamide-polyethyleneamine copolymers, and cationic resins having a five-membered amidine structure be used as the preferable cationic substance, because the color developing properties are excellent, uniform color with less bleeding can be realized, and an excellent image without uneven development can be formed.

When the cationic fine pigment is used, it is preferable that the content ratio of the cationic fine pigment be 50% by mass or more with respect to the total mass of the pigment contained in the ink receiving layer, because the transparency of the ink receiving layer becomes excellent and the ink absorption rate becomes rapid. When the content ratio of the cationic fine pigment is less than 50% by mass with respect to the total mass of the pigment, there is a case in which the transparency of the ink receiving layer deteriorates and image qualities such as printing density or the like deteriorate.

In the coating layer (ink receiving layer) according to the present invention, although the pigment and the thermosensitive polymeric compound are contained, various adhesives generally well-known and conventionally used for manufacturing coated sheets, such as water-soluble resins (such as polyvinyl alcohols such as polyvinyl alcohols, modified polyvinyl alcohols such as cation-modified polyvinyl alcohols, silyl-modified polyvinyl alcohols, or the like, casein, soy proteins, synthesized proteins, starch, cellulose derivatives such as carboxymethylcellulose, methylcellulose, or the like), aqueous dispersion resins of conjugated diene-based polymer latexes such as styrene-butadiene copolymers, methyl methacrylate-butadiene copolymers, or the like, vinyl-based copolymer latexes such as styrene-vinyl acetate copolymers, or the like, aqueous acrylic resins, aqueous polyurethane resins, aqueous polyester resins, or the like, may further be contained alone or in combination of at least two kinds thereof in an amount within a range that does not damage the effects of the thermosensitive polymeric compound. The aqueous polyurethane resins are also referred to as urethane emulsions, urethane latexes, polyurethane latexes, or the like. The polyurethane resins are produced by reaction of polyisocyanate compounds and active hydrogen-containing compounds, and are polymeric compounds having a relatively large number of urethane bonds and urea bonds.

In the coating layer (ink receiving layer), various auxiliary agents such as a preservation improving agent, an antifoam agent, a coloring agent, a fluorescent whitening agent, an antistatic agent, a preservative agent, a dispersing agent, a thickening agent, or the like, may be suitably contained.

When the coating liquid for the coating layer (ink receiving layer) is applied on the support or the undercoat layer superimposed on the support, various known coating devices, such as a blade coater, an air-knife coater, a roll coater, a brush coater, a champflex coater, a bar coater, a lip coater, a gravure coater, a curtain coater) a slot die coater, a slide coater, or the like, may be used. In particular, it is preferable that the application be carried out by a wet-on-wet method in which the coating liquid containing the thermosensitive polymeric compound is applied while the treatment liquid whose temperature is no higher than the thermosensitive point of the thermosensitive polymeric compound is not dried, the treatment liquid being applied concurrently with or before the application of the coating material.

After the coating layer (ink receiving layer) is formed, the coating layer is further cooled using a cooling device so as to perform thickening or gelatinization.

The glossiness of the coating layer can be enhanced using a well-known device such as a super calender, or the like. In particular, for the purpose of increasing the glossiness of the coating layer, after the coating layer (ink receiving layer) containing the thermosensitive polymeric compound is thickened or gelatinized, the layer may be finished by bringing it into contact with and pressing it against a heated mirror-finished drum while the wet state thereof remains, drying, and then separating from the mirror-finished drum, a so-called cast-finish, and such a cast-finish is carried out in a preferable aspect.

According to the present invention, at least one coating layer (ink receiving layer) mentioned above is formed. Two or more coating layers (ink receiving layers) containing the pigment and the thermosensitive polymeric compound as mentioned above may be formed. When two or more layers are formed, it is preferable that different pigments and thermosensitive polymeric compounds be selected from the above in terms of ink absorption and glossiness.

(With Respect to a Gloss Exhibiting Layer)

In the present invention, another gloss exhibiting layer may be formed as the uppermost layer on the coating layer (ink receiving layer) for the purpose of realizing higher glossiness, and it is preferable that such a gloss exhibiting layer be formed. It is preferable that a pigment contained in the gloss exhibiting layer be selected from monodisperse colloidal pigments with an average primary particle diameter of 0.01 to 0.06 μm, silicas with an average particle diameter of 1 μm or smaller, aluminum oxide, or pseudo-boehmite fine pigments. A monodisperse colloidal silica with an average primary particle diameter of 0.01 to 0.06 μm can realize favorable glossiness. Examples of the monodisperse colloidal silica include a cation-modified colloidal silica Moreover, aluminum oxide, pseudo-boehmite, and silica (particularly, fumed silica) are preferable in terms of scuff resistance of pigment ink suitability. The gloss exhibiting layer may suitably contain the binder used in the undercoat layer unless the ink absorption is deteriorated.

It is desirable that the gloss exhibiting layer be formed by a method in which contacting and pressing is carried out using a heated mirror-finished drum while a coating fluid of the gloss exhibiting layer is in a wet state, and then drying is carried out, that is, a so-called cast method. When the air-permeable support is used, the mirror face of the drum can be transferred to the surface of the gloss exhibiting layer by carrying out drying on the mirror-finished drum. When the non-air-permeable support is used, although drying cannot be carried out on the mirror-finished drum since the support is impervious to moisture, drying may be carried out, after the coating fluid is applied and the resultant material is brought into contact with and pressed against the mirror-finished drum. A release agent commercially available is suitably contained in the gloss exhibiting layer so as to promote release thereof from the mirror-finished drum. The suitable addition amount is 0.5 to 10 parts by mass with respect to 100 parts by mass of the pigment. When the addition amount is small, it becomes difficult for effects for improving releasability to be exhibited. In contrast, when the addition amount is high, there is a case in which the glossiness deteriorates, cissing of ink occurs, and recording density decreases.

Examples of the release agent include higher fatty acid esters such as potassium stearate, and the like, higher fatty acid amides such as stearic acid amide, oleic acid amide, and the like, polyolefin waxes such as polyethylene wax, oxidized polyethylene wax, polypropylene wax, and the like, higher fatty acid alkaline salts such as calcium stearate, zinc stearate, potassium oleate, ammonium oleate, and the like, silicone compounds such as lecithin, silicone oil, silicone wax, and the like, fluorine compounds such as polytetrafluoroethylene, and the like. Among these, the higher fatty acid amides are preferably contained, because the higher fatty acid amides can significantly improve releasability from the mirror-finished drum and suppress the occurrence of bleeding of a printed image.

It is preferable that the coating amount of the gloss exhibiting layer be within a range from 0.1 to 10 g/m², more preferably 0.2 to 5 g/m², and even more preferably 0.5 to 2 g/m². When the coating amount is small, the coated film becomes thin, and so interference color is easily generated by light. On the other band, when the coating amount is high, there is a possibility in which the ink absorption rate significantly deteriorates.

(With Respect to a Rear Surface Layer)

For the purpose of improving curling properties or conveyance properties, a rear surface layer may also be formed on the rear surface of the support. Also, a polyethylene layer may be formed as the rear surface layer so as to provide a texture of a film photo.

(With Respect to Ink)

An ink used in an inkjet recording method according to the present invention contains as essential components thereof a dye which forms an image and a liquid medium which dissolves and disperses the dye, and is prepared by adding various dispersing agents, surfactants, viscosity modifiers, resistivity modifiers, pH modifiers, fungicides, stabilizers for dissolved or dispersed recording agents, or the like, as needed.

Examples of a dye and pigment used in the ink include direct dyes, acid dyes, basic dyes, reactive dyes, edible dyes, dispersion dyes, oil dyes, and various pigments, and conventionally known ones may be used without any particular limitations. Although the content of the dye is determined depending on the kind of solvent component in the ink and properties required for the ink, the content of the dye used according to the present invention may be the same as that of a dye contained in a conventional ink, that is, the content may be approximately 0.1 to 20% by mass without causing any problems.

Examples of a solvent contained in the ink available for the present invention include water and various water-soluble organic solvents such as alcohols such as methyl alcohol, ethyl alcohol, n-propyl alcohol, isopropyl alcohol, n-butyl alcohol, isobutyl alcohol, 1,2-hexanediol, and the like, ketones or ketone alcohols such as acetone, diacetone alcohol, and the like, polyalkylene glycols such as polyethylene glycol, polypropylene glycol, and the like, alkylene glycols having 2 to 6 alkylene groups, such as ethylene glycol, propylene glycol butylene glycol, triethylene glycol, thiodiglycol, hexylene glycol, diethylene glycol, and the like, amides such as dimethylformamide, and the like, ethers such as tetrahydrofuran, and the like, lower alkyl ethers of polyvalent alcohol such as glycerin, ethyleneglycol methylether, diethyleneglycol methyl(ethyl) ether, triethyleneglycol monomethylether, and the like.

### EXAMPLES

In the following, although the present invention will be more specifically explained by way of examples, it is apparent that the present invention is not limited to these. Also, “parts” and “%” used in the examples indicate “parts by mass” and “% by mass” unless otherwise so indicated.

<Silica Fine Particle A>

100 parts of finned silica (manufactured by NIPPON AEROSIL CO., LTD., under the trade name of Aerosil A 300, with an average primary particle diameter of approximately 0.008 μm) were added to 10% aqueous solution containing 10 parts of a cationic compound with a diallyldimethyl ammonium chloride structure (manufactured by Nitto Boseki Co., Ltd., under the trade name of PAS-J-81, with a molecular weight of two hundred thousand) and dispersed using a homomixer. Then, the dispersion was pulverized using a high-pressure homogenizer until the average particle diameter thereof became 0.1 μm, and 10% aqueous dispersion was prepared.

<Silica Fine Particle B>

A wet-process silica with an average particle diameter of 2.0 μm (manufactured by Nippon Silica Industrial Co., Ltd., under the trade name of Nipsil HD), with an average primary particle diameter of approximately 0.013 μn) was dispersed using a sand grinder, and pulverized using a high-pressure homogenizer until the average particle diameter thereof became 0.4 μm, and 12% aqueous dispersion was prepared.

<Alumina Fine Particle A>

A high-purity alumina with an average particle diameter of approximately 3.0 μm (manufactured by Sumitomo Chemical Co., Ltd., under the trade name of AKP-G 015, γ-crystalline alumina oxide, with an average primary particle diameter of approximately 0.1 μm) was dispersed using a sand grinder and pulverized using a high-pressure homogenizer until the average particle diameter thereof became 0.25 μm, and 10% aqueous dispersion was prepared.

### Example 1

<Coating Liquid A>

20 parts of a thermosensitive polymeric compound that exhibits hydrophilicity at a temperature below the thermosensitive point thereof (manufactured by Asahi Kasei Corporation., under the trade name of ALB-221, with a thermosensitive point of 24° C.) were mixed with 100 parts of silica fine particle A, and 9% aqueous solution was prepared.

<Preparation of Inkjet Recording Sheet>

Water at a temperature of 2° C. was applied on a paper support (209 g/m², with a density of 0.9 g/cm³), and then a coating liquid A at a temperature of 40° C. was immediately applied and dried so that the coating amount became 15 g/m² to prepare an inkjet recording sheet.

### Example 2

<Coating liquid B>

20 parts of polyvinyl alcohol (manufactured by KURARAY CO., LTD., under the trade name of PVA-140H, with a polymerization degree of 4000 and a saponification degree of 99% or more) were mixed with 100 parts of silica fine particle B, and 10% aqueous solution was prepared.

<Preparation of Inkjet Recording Sheet>

On a paper support (209 g/m², with a density of 0.9 g/cm³), the coating liquid B at a temperature of 2° C. was applied so that the coating amount became 10 g/m², and the coating liquid A at a temperature of 40° C. was applied in a wet-on-wet manner so that the coating amount became 7 g/m², and then dried to prepare an inkjet recording sheet.

### Example 3

The coating liquid B was applied on both surfaces of a polyethylene-laminated paper (generally referred to as RC paper) in a coating amount of 10 g/m² and dried, to form an undercoat layer. Then, an aqueous solution containing 3% polyaluminum chloride at a temperature of 2° C. was applied on the undercoat layer, and then immediately the coating liquid A at a temperature of 40° C. was applied in a coating amount of 7 g/m² to prepare an inkjet recording sheet.

### Example 4

<Coating Liquid C>

An aqueous dispersion (at a concentration of 15%) was prepared in which 35 parts of polyvinyl alcohol (manufactured by KURARAY CO., LTD., under the trade name of R-1130) as a binder and 2 parts of diallyldimethyl ammonium chloride (manufactured by Nitto Boseki Co., Ltd., under the trade name of PAS-H-10L) as a cationic compound were added to 100 parts of a wet silica with an average particle diameter of 1.8 μm (manufactured by TOKUYAMA Corporation, under the trade name of FINESIL F-80).

<Preparation of Inkjet Recording Sheet>

On a paper support (209 g/m², with a density of 0.9 g/cm³), the coating liquid C was applied in a coating amount of 10 g/m², and then dried to form an undercoat layer. Then, 0.5% aqueous solution of diallyldimethyl ammonium chloride (manufactured by Nitto Boseki Co., Ltd., under the trade name of PAS-H-5L) at a temperature of 5° C. was applied, immediately after which the coating liquid A at a temperature of 35° C. was applied in a coating amount of 5 g/m², and then dried to prepare an inkjet recording sheet.

Peaks of the undercoat layer in a pore diameter distribution curve existed at 0.008 μm and 0.9 μm, and the pore volume thereof was approximately 1.05 ml/g.

### Example 5

An inkjet recording sheet was prepared in a similar manner to that in Example 1, except that water at a temperature of 15° C. was used instead of cold water at a temperature of 2° C.

### Example 6

An inkjet recording sheet was prepared by applying the coating liquid A prepared in Example 1, bringing the wet resultant into contact with and pressing it against a mirror-finished drum heated at 85° C. and then drying it.

### Example 7

<Coating Fluid D>

5 parts of a cationic release agent were added to 100 parts of a cation-modified colloidal silica with an average particle diameter of 45 nm and 8% aqueous solution was prepared.

<Preparation of Inkjet Recording Sheet>

On the inkjet recording sheet prepared in Example 1, the coating fluid D was applied in a coating amount of 1 g/m², immediately after which the resultant was brought into contact with and pressed against a mirror-finished drum heated at 90° C. and dried to prepare an inkjet recording sheet.

### Example 8

On the inkjet recording sheet prepared in Example 4, the coating fluid D was applied in a coating amount of 1 g/m², immediately after which the resultant was brought into contact with and pressed against a mirror-finished drum heated at 90° C. and then dried to prepare an inkjet recording sheet.

### Example 9

<Coating Fluid E>

5 parts of 30 nm cation-modified acrylic emulsion and 5 parts of a cationic release agent were added to 100 parts of alumina fine particle A, and 6% aqueous solution was prepared.

<Preparation of Inkjet Recording Sheet>

On the inkjet recording sheet prepared in Example 4, the coating fluid E was applied in a coating amount of 0.5 g/m², immediately after which the resultant was brought into contact with and pressed against a mirror-finished drum heated at 90° C. and then dried to prepare an inkjet recording sheet.

### Comparative Example 1

An inkjet recording sheet was prepared in a similar manner to that of Example 1, except that water at a temperature of 30° C. was used instead of cold water used in Example 1.

### Comparative Example 2

On the same support as in Example 1, the coating liquid A at a temperature of 40° C. was applied in a coating amount of 15 g/m² and then cooled to 10° C., and then the coated film was dried.

### Comparative Example 3

On the same support as in Example 4, the coating liquid C was applied in a coating amount of 10 g/m². Then, 0.5% aqueous solution of diallyldimethyl ammonium chloride (manufactured by Nitto Boseki Co., Ltd., under the trade name of PAS-H-5L) at a temperature of 30° C. was applied, immediately after which the coating liquid A at a temperature of 35° C. was applied in a coating amount of 5 g/m², and then dried.

<Evaluation Method>

The inkjet recording sheets prepared in such ways were evaluated as follows. As printers used for evaluation, the following printers A to D were used.

“Printer for Evaluation”

Printer A: Commercially available dye ink-type inkjet printer (manufactured by Seiko Epson Corporation, under the trade name of PM-950C)

Printer B: Commercially available pigment ink-type inkjet printer (manufactured by Seiko Epson Corporation, under the trade name of PM4000 PX)

Printer C: Commercially available pigment ink-type inkjet printer (manufactured by Seiko Epson Corporation, under the trade name of PX-G900)

Printer C: Commercially available pigment ink-type inkjet printer (manufactured by Seiko Epson Corporation, under the trade name of PX-V600)

(Cracking)

An image at ISO-100 (“High-fine color digital standard image data ISO/JIS-SCID” page 13, Image name: Portrait) was printed using Printer A (dye ink-type), and cracking occurring on the surface of the recording sheet was observed using an optical microscope. Although absence of cracking renders printed dots circular and image uniformity extremely favorable, existence of many cracks renders printed dots noncircular and image nonuniformity.

◯: Cracking was scarcely observed and image was uniform.

Δ: Although a few cracks were observed, image was relatively uniform.

X: Cracking was observed on the whole surface and image was nonuniform.

(Printing Density)

Black solid printing was carried out using printer A (dye ink-type) and the black solid portion was measured using a Macbeth reflection densitometer (Macbeth RD-920).

(Glossiness)

Image at ISO-400 (“High-fine color digital standard image data ISO/JIS-SCID” page 13, Image name: Portrait) was printed using Printer A, and the printed portion was visually observed from a lateral angle thereof and evaluated in accordance with the following criteria.

◯: There was glossiness at the same level as that of silver halide photography.

Δ: There was glossiness at the same level as that of generally commercially available art or coat paper.

X: There was low glossiness.

(Recording Suitability of Pigment Ink)

Images at ISO-400 (“High-fine color digital standard image data ISO/JIS-SCID” page 13, Image name: Portrait) were recorded using Printers B to D (pigment ink-type), and the uniformities of these recorded images were evaluated in accordance with the following criteria.

◯: Image was uniform and no spots were observed.

Δ: Although spots were observed on the image, image quality was at the practical level.

X: Many spots were observed on the image, and image quality was at the nonpractical level.

(Scuff Resistance of Pigment Image)

Images at IS 0400 (“High-fine color digital standard image data ISO/JIS-SCID” page 13, Image name: Portrait) were recorded using Printers B to D (pigment ink-type). These images were left for 24 hours after recording, and each image portion was rubbed with a swab to evaluate the scuff resistance thereof in accordance with the following criteria.

◯: No changes were observed in the image portion.

Δ: A part of the pigment in the image portion was rubbed away. However, there was no practical problem.

X: The pigment in the image portion was significantly rubbed away, and there was a practical problem.

TABLE 1

| | | Printing | | | | | | | |
|---|---|---|---|---|---|---|---|---|---|
| | Cracking | density | Glossiness | Recording suitability | | | Scuff resistance | | |
| | Printer | Printer | Printer | Printer | Printer | Printer | Printer | Printer | Printer |
| | A | A | A | B | C | D | B | C | D |
| Example 1 | ◯ | 2.25 | Δ | ◯ | ◯ | ◯ | ◯ | ◯ | ◯ |
| Example 2 | ◯ | 2.31 | Δ | ◯ | ◯ | ◯ | ◯ | ◯ | ◯ |
| Example 3 | ◯ | 2.35 | Δ-◯ | ◯ | ◯ | ◯ | ◯ | ◯ | ◯ |
| Example 4 | ◯ | 2.19 | Δ | ◯ | ◯ | ◯ | ◯ | ◯ | ◯ |
| Example 5 | Δ | 2.12 | Δ | Δ | ◯ | Δ | ◯ | ◯ | ◯ |
| Example 6 | ◯ | 2.36 | Δ-◯ | ◯ | ◯ | ◯ | ◯ | ◯ | ◯ |
| Example 7 | ◯ | 2.45 | ◯ | ◯ | ◯ | ◯ | Δ | ◯ | ◯ |
| Example 8 | ◯ | 2.46 | ◯ | ◯ | ◯ | ◯ | Δ | ◯ | ◯ |
| Example 9 | ◯ | 2.61 | ◯ | ◯ | ◯ | ◯ | ◯ | ◯ | ◯ |
| Comparative | X | 1.78 | X | X | X | X | ◯ | ◯ | ◯ |
| Example 1 | | | | | | | | | |
| Comparative | Δ | 2.09 | Δ | Δ | ◯ | Δ | ◯ | ◯ | ◯ |
| Example 2 | | | | | | | | | |
| Comparative | X | 1.65 | X | X | X | X | ◯ | ◯ | ◯ |
| Example 3 | | | | | | | | | |

Note:
Since a cooling step was required in Comparative Example 2, not only the steps thereof were complicated, but also cost required for equipment was high.

As is apparent from Table 1, the production process according to the present invention was convenient and significantly effective for controlling cracking. The obtained inkjet recording sheet had favorable image uniformity (dot roundness) and capability of providing glossiness and high printing density. Also, the obtained inkjet recording sheet was excellent in pigment suitability.

### INDUSTRIAL APPLICABILITY

According to the process for producing a coated sheet of the present invention, it is possible to form a coating layer simultaneously attaining an ink absorption rate and coating film cracking control suitable for use as an inkjet recording layer, in particular, there can be realized high gloss, high ink absorption, high printing density, high image quality (dot roundness) required from use as a glossy inkjet recording sheet.

When the process for producing a coated sheet according to the present invention is applied for manufacturing an inkjet recording sheet, it is possible to stably provide an inkjet recording sheet suitable for a dye-type or pigment-type inkjet printer airing at photo image quality.

The process for producing a coated sheet according to the present invention is not limited to be applied for producing an inkjet recording sheet, and the process may be applied for producing printing coated sheets such as art paper, coat paper, cast coated paper, or the like, as well as various recording sheets such as thermosensitive recording sheet, pressure sensitive recording sheet, thermal transfer recording sheet, electrophotography recording sheet, or the like.

1. A process for producing a coated sheet in which a support or an undercoat layer superimposed on the support is coated with a coating liquid containing a thermosensitive polymeric compound reversibly exhibiting hydrophilicity and hydrophobicity depending on temperature change, comprising:
applying on the support or the undercoat layer superimposed on the support a treatment liquid whose temperature is in a range in which the thermosensitive polymeric compound exhibits hydrophilicity; and
applying the coating liquid containing the thermosensitive polymeric compound concurrently with the application of the treatment liquid or after the application of the treatment liquid without drying after the application.

2. A process for producing a coated sheet according to claim 1, wherein the coating liquid containing the thermosensitive polymeric compound is thickened or gelatinized at a temperature within a range in which the thermosensitive polymeric compound exhibits hydrophilicity.

3. A process for producing a coated sheet according to claim 1 or 2, wherein a solvent of the treatment liquid is water.

4. A process for producing a coated sheet according to any one of claims 1 or 2, wherein the treatment liquid comprises at least one selected from the group consisting of cationic polymers and water-soluble polyvalent metal salts.

5. A process for producing a coated sheet according to any one of claims 1 or 2, wherein the coating liquid containing the thermosensitive polymeric compound comprises a pigment.

6. A process for producing a coated sheet according to any one of claims 1 or 2, wherein the coating liquid containing the thermosensitive polymeric compound comprises a cationic compound.

7. A process for producing a coated sheet according to any one of claims 1 or 2, wherein the thermosensitive polymeric compound exhibits hydrophobicity at a temperature no lower than a thermosensitive point thereof but exhibits hydrophilicity at a temperature no higher than the thermosensitive point.

8. A process for producing a coated sheet according to claim 7, wherein the temperature of the treatment liquid is lower than the thermosensitive point of the thermosensitive polymeric compound by 10° C. or more.

9. A process for producing a coated sheet according to any one of claims 1 or 2, wherein the coating liquid containing the thermosensitive polymeric compound comprises inorganic fine particles.

10. A process for producing a coated sheet according to any one of claims 1 or 2, wherein after a porous layer comprising inorganic fine particles and a binder as main components thereof is formed on the support, the treatment liquid is applied and the coating liquid containing the thermosensitive polymeric compound is applied.

11. A process for producing a coated sheet according to any one of claims 1 or 2, comprising a step in which after the coating liquid containing the thermo sensitive polymeric compound is applied, the resultant material is brought into contact with and pressed against a mirror-finished drum and dried.

12. A process for producing a coated sheet according to anyone of claims 1 or 2, comprising a step in which a coating fluid containing colloidal fine particles as a main component thereof is further applied onto a coating layer in which the coating liquid containing the thermosensitive polymeric compound is dried.

13. A process for producing a coated sheet according to any one of claims 1 or 2, wherein the coated sheet is a recording sheet.

14. A process for producing a coated sheet according to any one of claims 1 or 2, wherein the coated sheet is an inkjet recording sheet.

15. A process for producing an inkjet recording coated sheet, in which a porous layer containing inorganic fine particles and a binder as main components thereof is formed on a support, and then a coating liquid containing a thermosensitive polymeric compound reversibly exhibiting hydrophilicity and hydrophobicity depending on temperature change and inorganic fine particles is applied, comprising:
applying on the porous layer a treatment liquid whose temperature is in a range in which the thermosensitive polymeric compound exhibits hydrophilicity; and
applying the coating liquid containing the thermosensitive polymeric compound and the inorganic fine particles concurrently with the application of the treatment liquid or after the application of the treatment liquid without drying after the application.

16. A process for producing a coated sheet according to claim 15, wherein the porous layer has peaks in a pore distribution curve within each range of 0.1 to 10 μm and 0.5 μm or less, and a pore volume of 0.5 ml/g or more.
